(19) United States
(12) Patent Application Publication
(10) Pub. No.: US 2020/0234331 A1
(43) Pub. Date: Jul. 23, 2020

(54) SYSTEM AND PROCESS TO ESTIMATE PERSUASIVENESS OF PUBLIC MESSAGING USING SURVEYS

(71) Applicants: Michael Sadowsky, Chicago, IL (US); Patrick Miller, Chicago, IL (US); Keith Ingersoll, Chicago, IL (US); Allison Sullivan, Chicago, IL (US); Bill Lattner, Seattle, WA (US); David Shor, Chicago, IL (US); Jonathan Cobian, Chicago, IL (US)

(72) Inventors: Michael Sadowsky, Chicago, IL (US); Patrick Miller, Chicago, IL (US); Keith Ingersoll, Chicago, IL (US); Allison Sullivan, Chicago, IL (US); Bill Lattner, Seattle, WA (US); David Shor, Chicago, IL (US); Jonathan Cobian, Chicago, IL (US)

(21) Appl. No.: 16/250,421

(22) Filed: Jan. 17, 2019

(51) Int. Cl. G06Q 30/02

(52) U.S. Cl. CPC G06Q 30/0245; G06Q 30/0203; G06Q 30/0254

(57) ABSTRACT

A system and process to estimate persuasiveness of public messaging using surveys are disclosed. According to one embodiment, a method comprises selecting survey participants. Pre-screening question responses are received from the survey participants. The survey participants are divided randomly into a control group and a treatment group. The treatment group is shown a creative and a control group is shown nothing or a placebo. After the creative has been shown, participants are asked post-message questions such as purchase intent, favorability of the brand, and brand awareness. Weighting and bias correction are applied to question responses. An effects report is generated that includes an average treatment effect and a backlash probability for the creative, and treatment effects specific to subgroups.

### FIELD

The present disclosure relates in general to the field of computer software and systems, and in particular, to a system and process to estimate persuasiveness of public messaging using surveys.

### BACKGROUND

Before launching an expensive advertising campaign, traditional advertising methods have often employed focus groups who are exposed to new advertisements (also known as creatives). The focus groups answer surveys about the new advertisement that inform the advertiser whether a larger population would respond well to the new advertisement.

As Internet advertising has evolved with digital advertisements being shown on websites, new tools have evolved to help advertisers determine if an advertising campaign is effective. For example, Google™ offers Brand Lift that measures the direct impact advertisements are having on perceptions and behaviors throughout the consumer journey. Within a matter of days of launching an advertisement, Brand Lift provides insights into how advertisements are impacting metrics, including lifts in brand awareness, advertisement recall, consideration, favorability, purchase intent, and brand interest, as measured by organic search activity.

To measure the moments along the consumer journey, including brand awareness, advertisement recall, consideration, favorability, and purchase intent, Brand Lift isolates a randomized control group that was not shown the advertisement and an exposed group that did see the advertisement. About a day after seeing (or not seeing) the advertisement, Brand Lift delivers a one-question survey to both groups. Since the only effective difference between the two groups is whether they saw the advertisement, Brand Lift determines the lift attributed to the advertising campaign.

Problems with systems such as Brand Lift is that advertisers need to already have the advertising campaign in place in order to obtain any knowledge about whether the advertising campaign is effective. The time that passes may already be doing harm to the advertiser.

### SUMMARY

A system and process to estimate persuasiveness of public messaging using surveys are disclosed. According to one embodiment, a method comprises selecting survey participants. Pre-screening question responses are received from the survey participants. The survey participants are divided randomly into a control group and a treatment group. The treatment group is shown a creative and a control group is shown nothing or a placebo. After the creative has been shown, participants are asked post-message questions such as purchase intent, favorability of the brand, and brand awareness. Weighting and bias correction are applied to question responses. An effects report is generated that includes an average treatment effect and a backlash probability for the creative, and treatment effects specific to subgroups.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The accompanying figures, which are included as part of the present specification, illustrate the various embodiments of the presently disclosed system and method and together with the general description given above and the detailed description of the embodiments given below serve to explain and teach the principles of the present system and method.

FIG. 1 illustrates a prior process for determining the effectiveness of an advertisement.

FIG. 2 illustrates an exemplary advertising effects system, according to one embodiment.

FIG. 3 illustrates an exemplary advertisement effects reporting process, according to one embodiment.

FIG. 4 illustrates an exemplary effects report, according to one embodiment.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

A system and process to estimate persuasiveness of public messaging using surveys are disclosed. According to one embodiment, a method comprises selecting survey participants. Pre-screening question responses are received from the survey participants. The survey participants are divided randomly into a control group and a treatment group. The treatment group is shown a creative and a control group is shown nothing or a placebo. After the creative has been shown, participants are asked post-message questions such as purchase intent, favorability of the brand, and brand awareness. Weighting and bias correction are applied to question responses. An effects report is generated that includes an average treatment effect and a backlash probability for the creative, and treatment effects specific to subgroups.

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

For the purposes of this disclosure, the terms advertisement, message, and creative are used interchangeably for any video, image, or text message that is being evaluated for its effect on a target audience.

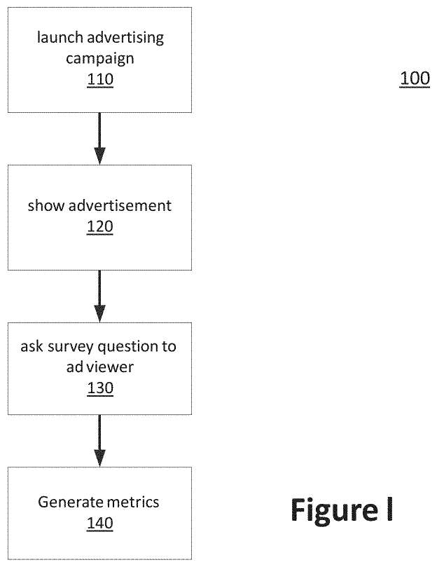

FIG. 1 illustrates a prior process for determining the effectiveness of an advertisement. The advertising effects process 100 begins by launching an advertising campaign (110). For example, a new advertising image or video is launched on a social networking platform. The advertisement is shown to a target audience (e.g., certain users of the social networking platform that fit a desired demographic) (120). Members of the target audience who viewed the advertisement are asked a survey question (130). Certain metrics are provided to the advertiser based upon the survey responses (140).

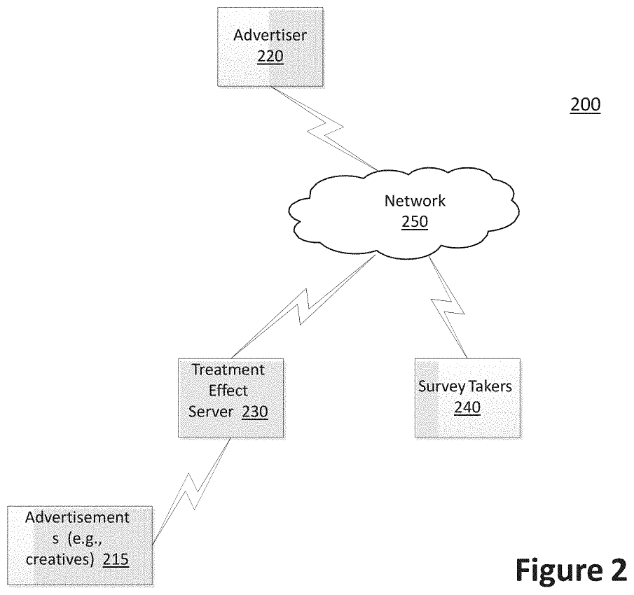

FIG. 2 illustrates an exemplary advertising effects system 200, according to one embodiment. A treatment effects server 230 determines the effect an advertisement will have on a desired target audience. The treatment effects server 230 receives advertisements 215 from advertiser 220 and generates surveys that are completed by survey takers 240. The treatment effects server 230 receives the survey responses from the survey takers 240. The survey responses are processed to eliminate bias and to properly weight the survey responses before treatment effect server 230 generates an effects report to the advertiser 230. The effects report provides an average treatment effect, treatment effects for particular demographics, best message probability, and backlash probability for each advertisement provided to the survey takers 240. The entities in system 200 are interconnected by network 250 (e.g., Internet). Advertiser 220 and survey takers may be computers, mobile computing devices, etc. with web browsers used by advertisers and survey takers.

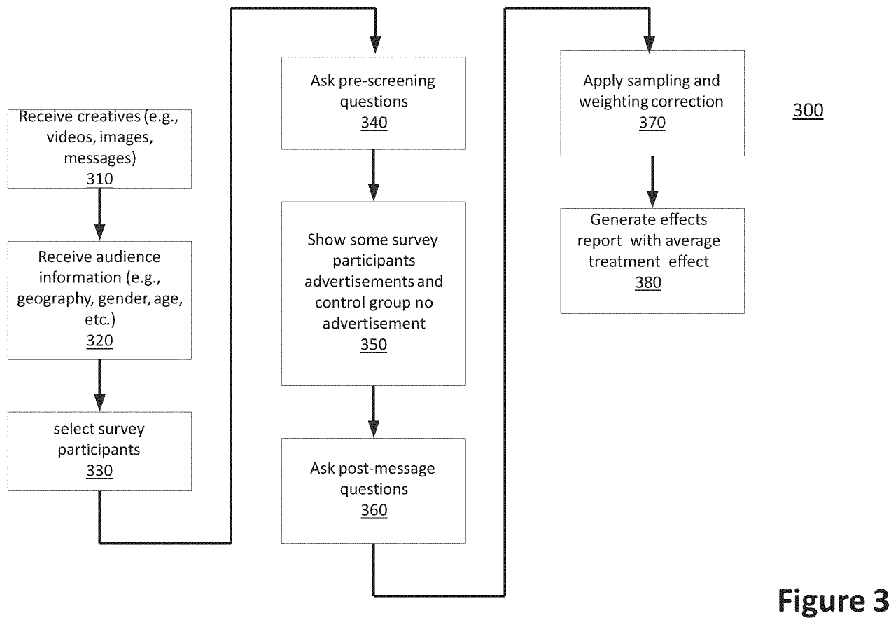

FIG. 3 illustrates an exemplary advertisement effects reporting process 300, according to one embodiment. Effects reporting process 300 begins when an advertiser 220 uploads its videos, images, or messaging to treatment effects server 230. (310) Advertiser 220 identifies the audience it wants to test, and provides a description of the advertising campaign. (320) Tests can be run for campaigns of any size, from national down to a single congressional district.

Using the audience information, treatment effects server 230 identifies a target survey audience 240. (330) Treatment effects server 230 generates pre-screening questions for the target survey audience 240 (340). Pre-screening questions may include basic demographic information (age, sex, race, income, etc.), voting history, lifestyle habits, consumer behaviors, political party affiliation, and political ideology. Treatment effects server 230 uses the responses to the pre-screening questions to determine the proper weighting needed to generate an effects report. Treatment effects server 230 sets demographic quotas to ensure that no single group of individuals is over-represented in the effects report.

Treatment effects server 230 shows the survey takers 340 the advertisement (e.g., a pre-released advertisement). (350) According to one embodiment, treatment effects server 230 randomly shows some people in survey takers 240 one advertisement, show other survey takers 240 a second advertisement (e.g., a control advertisement), and show other survey takers 240 no advertisement.

According to one embodiment, survey takers 240 are randomly placed in either a control or test condition. If they are in the control condition, they will see nothing and continue directly to the outcome questions. If they are in a test condition they will be shown one of the pieces of creative being tested. An individual will only see one potential piece of creative before moving forward in the survey.

Treatment effects server 230 ends the survey with outcome questions, such as likelihood to support a candidate, likelihood to purchase a product, or intent to take an action of interest. (360)

By measuring the opinions of each group in a survey and comparing them against one another, treatment effects server 230 can directly measure the impact of each advertisement on the outcomes that matter most, like candidate favorability and turnout likelihood. A randomized controlled trial allows for completely isolating the effect of the advertisement on the desired outcomes. When a difference in attitude between the group that saw that advertisement and the control, the system 200 can attribute that difference to the ad.

In addition to setting quotas before the survey begins, after the survey is completed, treatment effects server 230 weights the results using consumer file covariates (e.g., age, gender, and race/ethnicity) and Census microdata. This helps to correct for any imbalances that may have been introduced in the survey fielding process. (370) For example, treatment effects server 230 may estimate all effects together and then use hierarchical priors. For example, treatment effects server 230 may estimate all the effects together using a structured model which incorporates domain expertise and previous results. A distribution may be set over likely values for the mean and variance of treatment effects. Final treatment effect estimates are made from comparing responses from survey takers 240 to these prior belief distributions.

For example, one instance of this model might have a set of parameters for each treatment effect, for each consumer file covariate and for each combination of treatment effect and covariate. Each set of parameters arrives from a normal distribution centered at zero. For each set of parameters, five values representing the variance around this mean are chosen by experts and later updated with an automated process based on all previous tests performed. This model is trained in two stages. Initially, the model is trained on part of the survey data for each of the values of variance. The combination of values which minimize error on the held-out survey data are chosen for use in the next stage. With these selected values, the posterior estimates of the model parameters can be calculated using a Markov chain Monte Carlo algorithm. In this way, treatment effects server 230 can correct for all subgroups jointly (e.g., determine the effect of a survey taker's age if it is a controlling effect over income and gender.)

Treatment effects server 230 generates an effects report that indicates how the advertisement performed, measures any potential backlash, and identifies which subgroups of the population are most receptive to each advertisement.

Treatment effects server 230 determines which advertisement is most successful at obtaining campaign key performance indicators by measuring whether there are significant differences in how individuals (e.g., survey takers 240) respond to the post-message question depending on which test condition they were a part of. If individuals who saw the creative tests were much more likely to vote for a candidate than those who were in the control condition, we might determine that the advertisement is effective at increasing vote likelihood.

The present tool for analyzing the results of a survey experiment estimates the effect of various messages on key metrics. It models survey responses with a Bayesian logistic regression, applying a separate prior on the variance of main treatment effects, covariate effects and treatment-covariate interaction effects. The present tool selects these priors using cross-validation, choosing the priors that maximize log-likelihood on out-of-sample data.

The present tool makes comparisons across many different subgroups in addition to the overall comparisons. For example, the present tool determines if there is a different response to the advertisements among females or young people or Republicans.

The present tool jointly models all of the desired comparisons with survey data in a (weighted) logistic regression. This framework measures the uncertainty of the present tool's estimates and ensures that all estimates are consistent with each other. Furthermore, this framework allows for control of other variables about the survey takers that are not a specific subgroup to compare treatment effects over. Formally, the present model f(G,C, T) is:

$$f ( \text{?} , \text{?} , \text{?} ) = π ( {β}_{0} + {\sum }_{\text{?}}^{\text{?}} {β}_{g} G \text{?} + {\sum }_{\text{?}}^{\text{?}} β \text{?} C + {\sum }_{\text{?}}^{\text{?}} β \text{?} T \text{?} + {\sum }_{\text{?}}^{T} {\sum }_{\text{?}}^{G} {β}_{gt} \text{?} )$$

$$\text{?} \text{indicates text missing or illegible when filed}$$

Where
G is an indicator matrix for the subgroups of interest a respondent belongs to.
C is a matrix of other covariates known about the respondent.
T is an indicator matrix for which treatment (message) was assigned.
β₀, βₜ, β_{g}, βgt and β_{c} are the parameters of the regression model to be estimated.
π is the logistic function

$$π ( x ) = \frac{1}{1 + {e}^{- x}}$$

This model has four components:

$$treatment main effects = {\sum }_{\text{?}}^{T} β \text{?} T \text{?}$$

$$subgroup main effect = {\sum }_{\text{?}}^{G} β \text{?} G \text{?}$$

$$covariate main effect = {\sum }_{\text{?}}^{C} β \text{?} C \text{?}$$

$$heterogeneous treatment effect = {\sum }_{\text{?}}^{T} {\sum }_{\text{?}}^{G} β \text{?} T \text{?} G \text{?}$$

$$\text{?} \text{indicates text missing or illegible when filed}$$

The treatment main effect is the overall change in the key metric resulting from the various messages/advertisements shown. The subgroup and covariate main effect measure the different baseline levels of the key metric for each subgroup or covariate. Finally, the heterogeneous treatment effect is the estimated difference in treatment effect that is dependent on the subgroups a respondent belongs to. In this model, covariates are not included in the heterogeneous treatment effects.

The present tool separates each of these components because a different prior belief is held on the size of the effects for each one. For instance, the treatment main effects are trusted more than the heterogeneous treatment effects since the treatment assignment was experimentally designed and the heterogeneous effects are observational. Additionally, the subgroup and covariate effects may be larger on average than the treatment effects. For example, partisanship data would have a larger effect on candidate preference than any message/advertisement.

In order to incorporate these beliefs, the present tool estimates the coefficients in Bayesian framework with Markov chain Monte Carlo (MCMC) sampling. This approach allows the present tool to use prior beliefs to shrink the coefficients toward zero unless there is strong evidence supporting a nonzero effect. The priors for the present tool are as follows:

β˜ [symbol] (0,10)

β˜ [symbol] (0,σ₀)

ββ˜ [symbol] (0,σ₁)

β˜ [symbol] (0,σ₀γ)

### Where:

σ₀ is the variance for the main treatment effect

σ₁ is the variance for all subgroup and covariate main effects

σ₀γ is the variance for all interaction terms and 0<γ<=1.

A higher value for a prior on variance results in larger coefficients, so the present tool sets the prior for interaction terms to be a ratio equal to or smaller than the prior for the main treatment effect. This codifies the heuristic that since there are usually many interaction terms and each interaction term has only a few examples, extra regularization is required in order to avoid overestimating interaction effects.

During modeling, θ₀, θ₁ and γ are all estimated using cross validation. In each fold, a separate model is trained using a different combination of θ₀, θ₁ and γ (for speed of computation, only point estimates are calculated rather than full posteriors). Predictions are made on out-of-sample rows and the parameters which result in the highest log-likelihood on out-of-sample data are chosen. Once θ₀, θ₁ and γ have been chosen, the full model is trained using the complete survey dataset.

The present tool makes a prediction for every survey response setting T to the control message. That is, the present tool predicts the key metric for each respondent as if they had seen the control message. These are called the control estimates. Next, for each non-control message, the present tool makes another prediction for every respondent as if they had seen the non-control message. These are called the treated estimates. The estimated treatment effect for a given respondent is then the treated estimates minus the control estimates.

Ŷ^{k}=f(G,C,T=k)

T^{k}=Ŷ^{k}−Ŷ^{k=0}

### Where

k indicates the treatment, conventionally the control is defined as k=0

Ŷ^{k} are estimates of the key metric given a respondent was assigned message k

T^{k} is the treatment effect estimate for message k relative to the control message

Unlike a frequentist logistic regression, the present tool returns a distribution rather than a point estimate for each row of survey data. Therefore, Ŷ^{k} and T^{k} are matrices rather than column vectors, with n rows equal to the number of survey respondents and m columns equal to the number of post burn-in MCMC samples.

### Posteriors

In order to estimate subgroup specific toplines and treatment effects, Ŷ^{k}, and T^{k} may be subset by an arbitrary subgroup g. For instance, Ŷ^{k} may be subset to only the rows where a survey respondent was older than 65 in order to examine the model results for this demographic. Ŷ^{k} and all variables derived from Ŷ^{k}, including T^{k} may be subset by g. A subgroup g may be any particular subgroup, or an overarching group overall, in which case g includes all rows of Ŷ^{k}.

Under the assumption that Ŷ^{k} is subset to g, the present tool defines the posteriors for a specific subgroup to be the weighted column-wise mean over Ŷ^{k}:

$${\hat{y}}_{j}^{k} = \frac{{\sum }_{i}^{n} {w}_{i} {\hat{Y}}_{ij}^{k}}{{\sum }_{i}^{n} {w}_{i}}$$

Where w is a vector of survey respondent weights. This results in a row vector where each element is the expected value of subgroup g for a different sample of the model f. This vector may be viewed as the posterior estimates of f(G, C, T) on a single, average respondent of subgroup g. From these posteriors model results are derived, including the toplines, treatment effects, error terms around the estimates, probability best treatment and probability of backlash.

### Toplines and Treatment Effects

A topline is the best estimate of a key metric for a specific subgroup g after being treated with message k. The present tool defines a topline to be the median of the posterior ŷ^{k}. Likewise, the present tool's reported average treatment effects are the median of the posterior distribution τ k.

$$control topline = med ( {\hat{y}}^{k} \text{?} ) \text{:}$$

$$treatment topline = med ( \text{?} )$$

$$average treatment effect = med ( {τ}^{k} )$$

$$\text{?} \text{indicates text missing or illegible when filed}$$

The present tool measures uncertainty in the toplines and treatment effects using the poles of an 80% highest density posterior to describe the variation of the posterior estimates.

### Probability Best Treatment and Backlash

Probability of best treatment measures the probability that a given message will increase the key metric more than all other messages, including the control. It is used to rank messages and help determine which message is most persuasive. It is estimated by finding the percentage of MCMC samples where a treatment effect for message k is higher than the treatment effect for all other messages. This procedure is done for each individual subgroup as well as overall.

$$\text{?} ( τ \text{?} ) = \{ \begin{matrix}1 & if τ \text{?} \\ 0 & otherwise\end{matrix} \\ P ( {τ}^{k} = {τ}^{*} ) = \frac{1}{m} {\sum }_{i}^{m} best ( {τ}_{i}^{k} ) \\ \text{?} \text{indicates text missing or illegible when filed}$$

τ* is the best message for group g among the set of messages tested.

The probability of backlash is the probability that a given message has a negative treatment effect. Rather than compare against all messages as is performed for probability of best treatment, each message is only compared to the control message when calculating the probability of backlash.

$$backlash ( {r}_{i}^{j} ) = \{ \begin{matrix}1 & if {τ}_{i}^{k = j} < {r}_{i}^{k - 0} \\ 0 & otherwise\end{matrix} \\ P ( {τ}^{k} < {τ}^{k - 0} ) = \frac{1}{m} {\sum }_{i}^{m} backlash ( {r}_{i}^{k} )$$

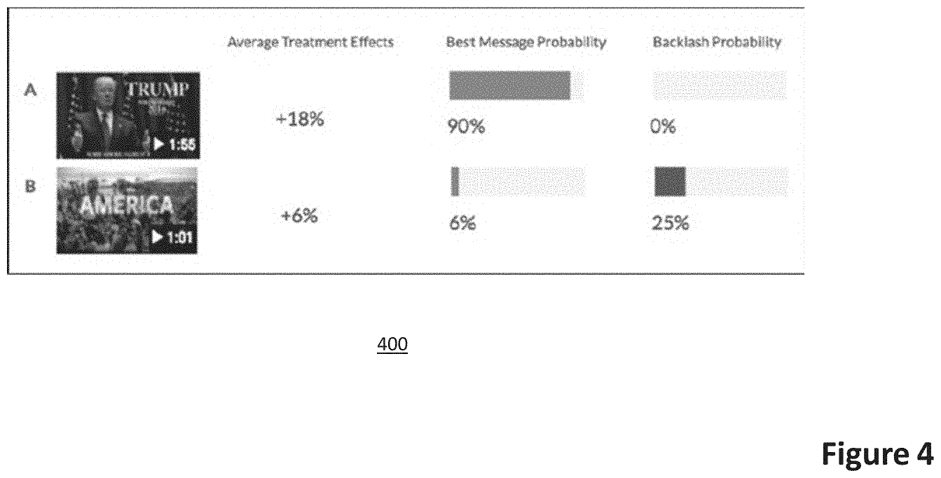

FIG. 4 illustrates an exemplary effects report 400, according to one embodiment. In the example of FIG. 4, individuals who were exposed to Ad “A” were 18% points more likely to say they would vote for the candidate in question than those who were not shown a message. This means the message was more effective than a control, as well as more effective than the other potential piece of creative.

In addition to an overall picture of which advertisement is more effective, treatment effects server 230 also analyzes results by different subgroups including:

Income

Education

Age

Gender

Party & Ideology

Presidential Vote Choice in 2016

Media Use (CNN, MSNBC, Fox, Local News, Facebook)

Treatment effects server 230 can determine if a particular piece of advertising is only effective for a certain subset of the population, but not others.

While the present disclosure has been described in terms of particular embodiments and applications, summarized form, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the scope of the present disclosure.

What is claimed is:

1. A method, comprising:
selecting survey participants;
receiving pre-screening question responses;
dividing randomly the survey participants into a control group and a treatment group;
show the treatment group a creative and a control group nothing;
receiving post-message question responses;
applying weighting and bias correction to the post-message question responses; and
generating an effects report including an average treatment effect and a backlash probability for the creative.

2. The method of claim 1, further comprising generating a subgroup and covariate main effect that measure different baseline levels of a key metric for the control group and the treatment group.

3. The method of claim 2, further comprising generating a heterogeneous treatment effect that is an estimated difference in treatment effect that is dependent on subgroups a respondent belongs to.

4. The method of claim 3, further comprising generating a prediction for each survey participant as if the survey participant had seen the creative.

5. The method of claim 3, further comprising wherein for each non-control message, generating a prediction for each survey participant if the survey participant had seen nothing.

6. The method of claim 3, further comprising a subgroup from the survey participants.

7. The method of claim 6, further comprising an estimate of a key metric for the subgroup after being treated with the creative.

8. The method of claim 6, further comprising ranking multiple creatives for the subgroup of a plurality of subgroups.

9. The method of claim 8, wherein the backlash probability is a probability that the creative has a negative treatment effect by comparing the creative to a control message.

10. A non-transitory computer readable medium containing computer-readable instructions stored therein for causing a computer processor to perform operations comprising:
selecting survey participants;
receiving pre-screening question responses;
dividing randomly the survey participants into a control group and a treatment group;
show the treatment group a creative and a control group nothing;
receiving post-message question responses;
applying weighting and bias correction to the post-message question responses; and
generating an effects report including an average treatment effect and a backlash probability for the creative.

11. The non-transitory computer readable medium of claim 10, further comprising generating a subgroup and covariate main effect that measure different baseline levels of a key metric for the control group and the treatment group.

12. The non-transitory computer readable medium of claim 11, further comprising instructions for generating a heterogeneous treatment effect that is an estimated difference in treatment effect that is dependent on subgroups a respondent belongs to.

13. The non-transitory computer readable medium of claim 12, further comprising instructions for generating a prediction for each survey participant as if the survey participant had seen the creative.

14. The non-transitory computer readable medium of claim 12, wherein for each non-control message, generating a prediction for each survey participant if the survey participant had seen nothing.

15. The non-transitory computer readable medium of claim 12, further comprising a subgroup from the survey participants.

16. The non-transitory computer readable medium of claim 15, further comprising an estimate of a key metric for the subgroup after being treated with the creative.

17. The non-transitory computer readable medium of claim 15, further comprising instructions for ranking multiple creatives for the subgroup of a plurality of subgroups.

18. The non-transitory computer readable medium of claim 17, wherein the backlash probability is a probability that the creative has a negative treatment effect by comparing the creative to a control message.
